(19) United States
(12) Patent Application Publication
(10) Pub. No.: US 2023/0206944 A1
(43) Pub. Date: Jun. 29, 2023

(54) HEAD SUSPENSION ASSEMBLY AND DISK DEVICE

(71) Applicants: TOSHIBA ELECTRONIC DEVICES & STORAGE CORPORATION, Tokyo (JP); KABUSHIKI KAISHA TOSHIBA, Tokyo (JP)

(72) Inventors: Kenichiro Aoki, Machida Tokyo (JP); Takuma Kido, Mitaka Tokyo (JP)

(21) Appl. No.: 17/821,984

(22) Filed: Aug. 24, 2022

(30) Foreign Application Priority Data
Dec. 28, 2021 (JP) 2021-213674

(51) Int. Cl. G11B 5/48

(52) U.S. Cl. CPC G11B 5/484; G11B 5/486

(57) ABSTRACT

According to one embodiment, a head suspension assembly includes a base plate including a first main surface, a second main surface opposing the first main surface, a distal end portion and a recess formed in the distal end portion on a side of the first main surface, a load beam including a proximal end portion disposed in the recess and fixed to a bottom surface of the recess and extending from the base plate, a wiring member disposed on the first main surface of the base plate and the load beam and a magnetic head supported by the load beam via the wiring member.

### CROSS-REFERENCE TO RELATED APPLICATIONS

This application is based upon and claims the benefit of priority from Japanese Patent Application No. 2021-213674, filed Dec. 28, 2021, the entire contents of which are incorporated herein by reference.

### FIELD

Embodiments described herein relate generally to a head suspension assembly and a disk device comprising the same.

### BACKGROUND

As a disk device, for example, a hard disk drive (HDD) comprises a magnetic disk installed in a housing, a spindle motor that supports and rotates the magnetic disk, a head actuator that supports a magnetic head, a voice coil motor that drives the head actuator, a flexible printed circuit board unit, and the like.

The head actuator includes an actuator block pivotably supported around a support shaft, a plurality of arms extending from the actuator block, a head suspension assembly (which may as well be referred to as a head gimbal assembly (HGA)) connected to an extending end of each arm.

The head suspension assembly includes a base plate fixed to the arms, a load beam extending from the base plate, a wiring member (flexure) disposed on the base plate and the load beam, and a magnetic head supported at a distal end portion of the load beam via the wiring member. A proximal end portion of the load beam is superimposed on a surface of the base plate and fixed to the base plate.

When a shock or the like is applied to the HDD while the magnetic head is loaded onto the disk, the load beam vibrates significantly around the magnetic head as the fulcrum. Therefore, there is a possibility that the load beam may be brought into contact with the disk, causing damage to the disk. In order to avoid contact between the load beam and the disk, it is necessary to widen the gap between the disk and the load beam.

### BRIEF DESCRIPTION OF THE DRAWINGS

FIG. 1 is a perspective view of a hard disk drive (HDD) according to a first embodiment with a top cover thereof disassembled.

FIG. 2 is a perspective view of an actuator assembly and a substrate unit of the HDD.

FIG. 3 is a perspective view of a head suspension assembly of the head actuator assembly.

FIG. 4 is an exploded perspective view of a distal end portion of the base plate of the head suspension assembly and a proximal end portion of a load beam.

FIG. 5 is a plan view of a distal end portion of the base plate and the proximal end portion of the load beam in a joined state.

FIG. 6 is a cross-sectional view of the base plate and the load beam taken along line A-A in FIG. 5.

FIG. 7 is a side view schematically showing the positional relationship between the magnetic disk and the head suspension assembly.

FIG. 8 is a diagram showing the head suspension assembly of the first embodiment and a head suspension assembly of a comparative example, comparing a Z-height at various positions along the X-direction.

FIG. 9 is an exploded view of a distal end portion of a base plate and a proximal end portion of a load beam of a head suspension assembly according to the second embodiment.

FIG. 10 is a plan view of the distal end portion of the base plate and the proximal end portion of the load beam in the second embodiment in a joined state.

FIG. 11 is a plan view showing a distal end portion of a base plate, a proximal end portion of a load beam, and a flexure of a head suspension assembly according to the third embodiment.

### DETAILED DESCRIPTION

Various embodiments will be described hereinafter with reference to the accompanying drawings. In general, according to one embodiment, a head suspension assembly comprises a base plate including a first main surface, a second main surface opposing the first main surface, a distal end portion and a recess formed in the distal end portion on a side of the first main surface; a load beam including a proximal end portion disposed in the recess and fixed to a bottom surface of the recess, and extending from the base plate; a wiring member arranged on the first main surface of the base plate and the load beam; and a magnetic head supported by the load beam via the wiring member.

The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

### First Embodiment

As a disk device, a hard disk drive (HDD) according to a first embodiment will be described in detail.

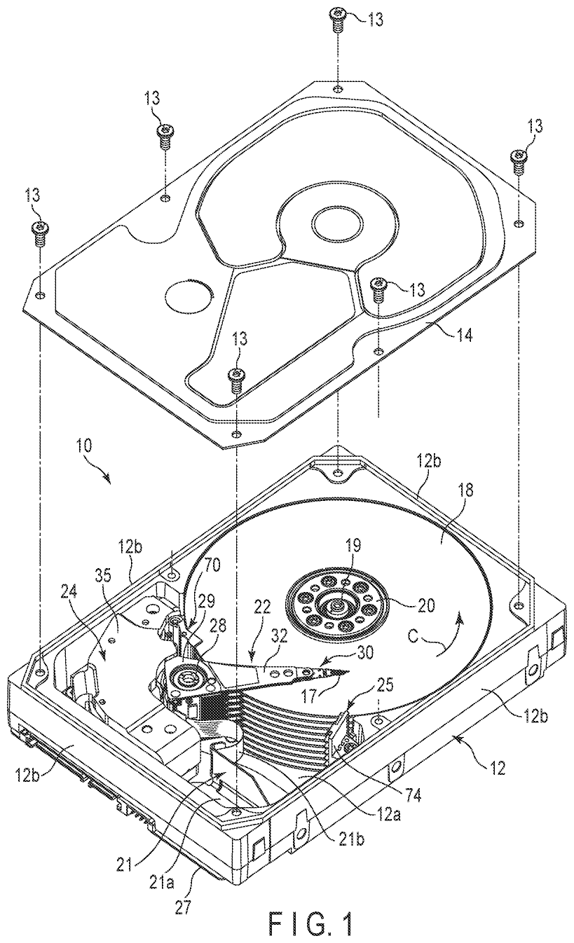

FIG. 1 is an exploded perspective view of the HDD of the first embodiment shown with a top cover removed.

As shown in FIG. 1, the HDD comprises a rectangular-shaped housing 10. The housing 10 has a rectangular box-shaped base 12 with an upper opening and a cover (top cover) 14. The base 12 includes a rectangular bottom wall 12a and side walls 12b standing along peripheral edges of the bottom wall 12a, and is formed of, for example, aluminum, to be integrated with each other as one body. The cover 14 is formed of, for example, stainless steel into a rectangular plate shape. The cover 14 is fixed onto the side walls 12b of the base 12 with a plurality of screws 13 to hermetically close the upper opening of the base 12. Inside the housing 10, a plurality of, for example, ten magnetic disks 18 as disk-shaped recording media, and a spindle motor 19 for supporting and rotating the magnetic disks 18 are provided. The spindle motor 19 is disposed on the bottom wall 12a. Each magnetic disk 18 includes a substrate formed of a non-magnetic material, for example, glass into a discoidal shape having a diameter of 95 mm (3.5 inches), and magnetic recording layers formed respectively on an upper surface (a first surface) and a lower surface (a second surface) of the substrate. The magnetic disks 18 are fitted to the hub of the spindle motor 19 so as to be coaxial with each other and is further clamped by a clamping spring 20. With this structure, the magnetic disks 18 are supported at predetermined intervals, parallel to each other and substantially parallel to the bottom wall 12a. The magnetic disks 18 are rotated by the spindle motor 19 in the direction of arrow C at a predetermined rotation number. The number of magnetic disks 18 mounted is not limited to ten, but may be nine or less, or ten or more, or twelve or less.

Inside the housing 10 are provided a plurality of magnetic heads 17 which record and reproduce information with respect to the magnetic disks 18, and an actuator assembly 22 which supports the magnetic heads 17 so as to be movable with respect to the magnetic disk 18. In the housing 10 are provided a voice coil motor (VCM) 24 that rotates and positions the actuator assembly 22, a ramp load mechanism 25 which holds the magnetic head 17 in an unload position spaced apart from the respective magnetic disk 18 when the magnetic head 17 moves to an outermost circumference of the respective magnetic disk 18, a substrate unit (FPC unit) 21 on which electronic components such as conversion connectors are mounted, and a spoiler 70. The VCM 24 includes a pair of yokes 35 provided on the bottom wall 12a and magnets fixed to the yokes 35, which are not shown in the figure. The ramp load mechanism 25 includes a ramp 74 on the bottom wall 12a.

A printed circuit board 27 is fixed to an outer surface of the bottom wall 12a of the base 12, by screws. The printed circuit board 27 constitutes a controller that controls the operation of the spindle motor 19 and the operation of the VCM 24 and the magnetic heads 17 via the substrate unit 21.

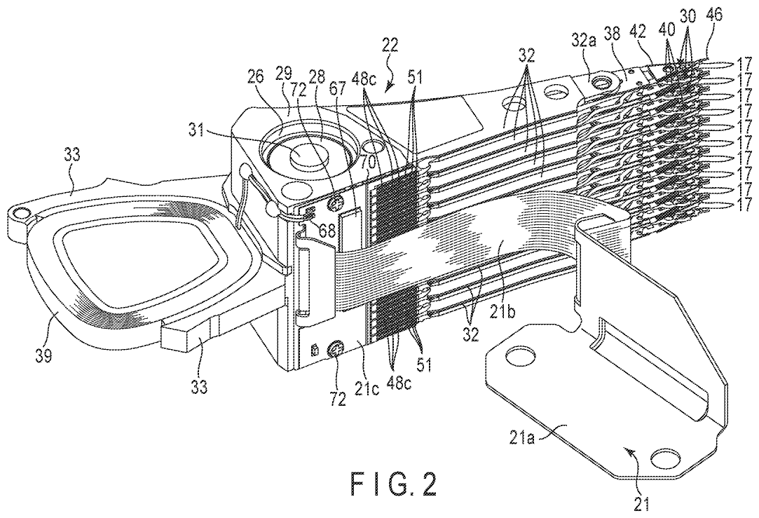

FIG. 2 is a perspective view of the actuator assembly. As shown in the figure, the actuator assembly 22 comprises an actuator block 29 with a through-hole 26, a bearing unit (unit bearing) provided in the through-hole 26, a plurality of, for example, eleven, arms 32 extending from the actuator block 29, a suspension assembly (a head gimbal assembly, which may as well be referred to an HGA) attached to each arm 32, and magnetic heads 17 supported by the suspension assemblies 30. A support shaft (pivotal axis) 31 is provided to stand on the bottom wall 12a of the base 12. The actuator block 29 is pivotally supported by the bearing unit 28 around the support shaft 31.

In this embodiment, the actuator block 29 and the eleven arms 32 are molded from aluminum or the like to be integrated into one body, thus constituting the so-called E block. The arms 32 are each formed into a slender flat plate and extend from the actuator block 29 in a direction perpendicular to the support shaft 31. The eleven arms 32 are provided parallel to each other with gaps therebetween.

The actuator assembly 22 includes a support frame 33 extending from the actuator block 29 in a direction opposite to the arms 32. The support frame 33 supports a voice coil 39 that constitutes a part of the VCM 24.

As shown in FIG. 1, the voice coil 39 is located between the pair of yokes 37, one of which is fixed to the base 12, and the voice coil 39, the yokes 37 and the magnets fixed to the yokes constitute the VCM 24.

As shown in FIG. 2, the actuator assembly 22 comprises twenty head suspension assemblies 30, each supporting a magnetic head 17. The head suspension assemblies 30 are respectively mounted on the extending ends 32a of the arms 32. The head suspension assemblies 30 include an up-head suspension assembly that supports the magnetic head 17 upwardly and a down-head suspension assembly that supports the magnetic head 17 downwardly. The up-head suspension assembly and the down-head suspension assembly are constituted by arranging the head suspension assemblies of the same structure in different vertical orientations.

In this embodiment, in FIG. 2, the down-head suspension assembly 30 is attached to the uppermost arm 32, and the up-head suspension assembly 30 is attached to the lowermost arm 32. On respective ones of the middle nine arms 32, the up-head suspension assembly 30 and the down-head suspension assembly 30 are attached. The head suspension assembly 30 includes a substantially rectangular base plate 38, a load beam 42 made of a slender plate spring and a slender strip flexure (wiring member) 40. The flexure 40 includes a gimbal portion, which is described below, on which the respective magnetic head 17 is placed. The proximal end portion of the base plate 38 is fixed to the extending end 32a of the arm 32 and caulked, for example. The proximal end portion of the load beam 42 is fixed while overlapping the distal end portion of the base plate 38. The load beam 42 extends from the base plate 38 and tapers down toward the extending end. The load beam 42 generates a spring force (reaction force) which urges the magnetic head 17 toward the surface of the magnetic disk 18. Further, a tab 46 protrudes from the distal end portion of the load beam 42. The tab 46 is engageable with the ramp 74 described above, and forms the ramp load mechanism 25 together with the ramp 74.

As shown in FIG. 2, the FPC unit 21 includes an substantially rectangular base portion 21a bent into an L shape, a slender strip-shaped relay portion 21b extending from one side edge of the base portion 21a, and a joint portion provided continuously in a distal end portion of the relay portion 21b. The base portion 21a, the relay portion 21b, and the joint portion 21c are formed by a flexible printed circuit board (FPC). The flexible printed circuit board includes an insulating layer such as of polyimide, a conductive layer formed on the insulating layer and forming a plurality of wiring lines, connection pads and the like, and a protective layer which covers the conductive layer.

On the base portion 21a, electronic components such as conversion connectors, a plurality of capacitors and the like, not shown in the figure, are mounted and electrically connected to the wiring lines, not shown in the figure. A metal plate which functions as a reinforcing plate is affixed to the base portion 21a. The base portion 21a is provided on the bottom wall 12a of the base 12. The relay portion 21b extends from the side edge of the base portion 21a toward the actuator block 2 9 and extends toward the actuator block 2. The joint portion 21c is formed into a rectangular shape having a height and a width substantially equal to a side surface (mounting surface) of the actuator block 29. The joint portion 21c is affixed to the mounting surface of the actuator block 29 via a backing plate made of aluminum or the like, and is further screwed and fixed to the mounting surface with a fixing screw 72. A number of connection pads are provided on the joint portion 21c. For example, one head IC (head amplifier) 67 is mounted on the joint portion 211c and the head IC 67 is connected to the connection pads and the base portion 21a via wiring lines. Further, the joint portion 211c is provided with a connection terminal 68 to which the voice coil 39 is connected.

The flexure 40 of each of the head suspension assemblies 30 includes one end electrically connected to the respective magnetic head 17, an other end extending through a groove formed in a side edge of the arm 32 to the actuator block 29, and a connection end portion (a tail connection terminal portion) 48c provided at the other end. The connection end portion 48c is formed into a slender rectangular shape. A plurality of, for example, thirteen, connection terminals (connection pads) 51 are provided at the connection end portion 48c. The connection terminals 51 are connected to the wiring lines of the flexure 40, respectively. That is, the wiring lines of the flexure 40 extend over substantially the entire length of the flexure 40, one end thereof is electrically connected to the magnetic head 17 and the other end is connected to the connection terminals (connection pads) 51.

The connection terminals 51 provided in the connection end portion 48c of each of the twenty flexures 40 are joined to the connection pads of the joint portion 21c and electrically connected to the wiring lines of the joint portion 21c via the connection pads. As a result, the twenty magnetic heads 17 of the actuator assembly 22 are electrically connected to the base portion 21a respectively via the wiring lines of the flexures 40, the connection end portions 48c, the joint portion 21c and the relay 21b of the FPC unit 21.

In the state of the actuator assembly 22 configured as described above assembled on the base 12, as shown in FIG. 1, the support shaft 31 is provided to stand substantially parallel to the spindle of the spindle motor 19. The magnetic disks 18 are each located between each respective pair of the head suspension assemblies 30. When the HDD is in operation, the magnetic heads 17 each supported by each respective pair of the head suspension assemblies 30 oppose the upper surface and the bottom surface of each of the magnetic disks 18.

Next, the configuration of the head suspension assembly 30 will be described in detail.

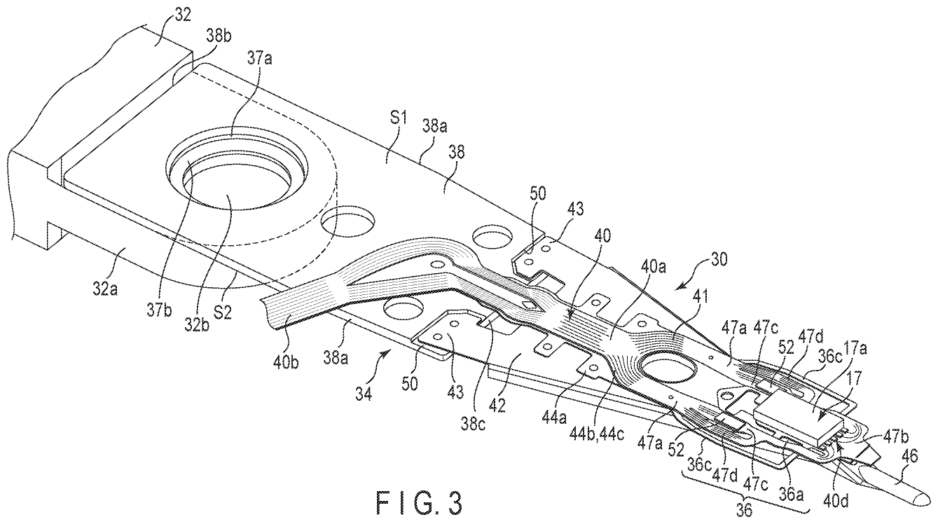

FIG. 3 is perspective view showing a magnetic head side of the head suspension assembly.

As shown in the figure, the head suspension assembly 30 includes a suspension 34 which serves as a support plate. The suspension 34 includes a rectangular base plate 38 made of a metal plate having a thickness of several hundred micrometers, and a slender plate spring-like load beam 42 made of a metal plate having a thickness of several tens of micrometers. For example, the base plate 38 is formed to have a thickness of about 130 μm, and the load beam 42 is formed to have a thickness of about 30 μm. The base plate 38 includes substantially rectangular first main surface S1 and second main surface S2 opposing each other, and a proximal end portion, and a distal end portion along the longitudinal direction. The base plate 38 includes a pair of side edges 38a opposing each other, one end edge 38b on a proximal end side and another end edge (distal end edge) 38c on a distal end side, which intersect the base edges 38a. When the head suspension assembly 30 is assembled into the HDD, the first main surface S1 of the base plate 38 opposes the respective magnetic disk 18.

In this embodiment, the proximal end portion of the load beam 42 includes a pair of proximal end portions 43 split into two halves, and the proximal end portions 43 constitute a hinge portion of the load beam 42. The pair of proximal end portions 43 are placed while overlapping on the distal end portion of on a side of the first main surface S1 of the base plate 38, and a plurality of places are fixed to the base plate 38 by welding. The load beam 42 extends from the base plate 38. The width of the proximal end portion of the load beam 42 is substantially equal to the width of the base plate 38. The load beam 42 is formed to taper down, that is, the width thereof gradually narrows from the proximal end portion towards the distal end portion. A slender rod-shaped tab 46 protrudes from the distal end portion of the load beam 42.

The base plate 38 has a circular through-hole (caulking hole) 38a formed at its proximal end portion and a circular flange 37b located around the through-hole 37a. The flange 37b extends into the through-hole hole 37a and also protrudes on the side of the second main surface S2.

The extending end (distal end portion) 32a of the arm 32 forms a thin caulking portion (fixing portion). A caulking hole 32b is formed through the distal end portion 32a. The proximal end portion of the base plate 38 is placed on the mounting surface of the distal end portion section 32a on a second main surface S2 side, and the flange 37b is fit into the caulking hole 32b of the distal end portion 32a, and fastened to the distal end portion 32a by caulking. Thus, the base plate 38 is fixed to the distal end portion 32a of the respective arm 32.

As shown in FIG. 3, the head suspension assembly 30 includes a pair of piezoelectric elements (PZT elements) 52, and a slender strip-shaped flexure (wiring member) 40 for transmitting recording and reproducing signals and drive signals of the piezoelectric element 52. The flexure 40 including a distal end side portion 40a mounted on the load beam 42 and the base plate 38, and a later half portion (extending portion) 40b extending outward from the side edge of the base plate 38 and extending along the side edge of the respective arm 32 (see FIG. 2). The connection end portion 48c located at the distal end portion of the extending portion 40b is connected to the joint portion 21c of the FPC unit 21 described above.

The distal end portion of the flexure 40 located on the distal end portion of the load beam 42 constitutes a gimbal portion 36 which functions as an elastic support portion. The magnetic head 17 is placed and fixed on the gimbal portion 36 and is supported by the load beam 42 via the gimbal portion 36. A pair of piezoelectric elements 52 as driving elements are mounted on the gimbal portion 36 and are located on the proximal end portion side of the load beam 42 with respect to the magnetic head 17.

The flexure 40 includes a thin metal sheet (metal plate) 44a, such as stainless steel, which serves as the base, and a strip-shaped stacked member 41 affixed or fixed on the metal sheet 44a, and forms a slender stacked plate. The stacked member 41 includes a base insulating layer 44b, most of which is fixed to the metal sheet 44a, a conductive layer (wiring pattern) 44c formed on the base insulating layer 44b and constituting a plurality of signal wiring lines and drive wiring lines, and a cover insulating layer stacked on the base insulating layer 44b to cover the conductive layer 44c. In the distal end portion side portion 40a of the flexure 40, the thin metal sheet 44a side thereof is attached on the load beam 42 and the surface of the base plate 38, or spot-welded at a plurality of welding points.

In the gimbal portion 36, the metal sheet 44a includes a rectangular tongue portion (support portion) 36a located on the distal end portion side, and a pair of slender outriggers (link portions) 36c extending from the tongue portion 36a to the distal end portion. The tongue portion 36a is formed to have a size and shape on which the magnetic head 17 can be mounted, which is, for example, rectangular. The tongue portion 36a includes a substantially center portion brought into contact with a dimple (protruding portion) protruding on the distal end portion of the load beam 42. The tongue portion 36a can be displaced in various directions using the dimple as the fulcrum by elastic deformation of the pair of outriggers 36c. Therefore, the tongue portion 36a and the magnetic head 17 mounted on the tongue portion 36a can flexibly follow the surface variation of the magnetic disk 18 in the roll and pitch directions and maintain a small gap between the surface of the magnetic disk 18 and the magnetic head 17.

In the gimbal portion 36, a portion of the stacked member 41 is split into two halves and located on respective sides of the central axis line of the suspension 34. The stacked member 41 includes a pair of proximal end portions 47a fixed to the metal sheet 44a, a distal end portion section 47b affixed on the tongue portion 36a, and a pair of strip-shaped first bridge portions 47c extending from the proximal end portions 47a to the distal end portion portions 47b, and a pair of first bridge portions 47c and a pair of strip-shaped second bridge portions (branching portions) 47d, aligned with the first bridge portions 47c, each extending from the proximal end portion 47a to the midpoint of the first bridge portions 47c to merge the first bridge portions 47c.

The magnetic head 17 includes a substantially rectangular slider 17a, and the slider 17a is fixed to the tongue portion 36a by adhesive. The magnetic head 17 is arranged so that the longitudinal central axis of the magnetic head 17 coincides with the central axis of the suspension 34, and the substantially center portion of the magnetic head 17 is located on the dimple. The recording and reproducing elements of the magnetic head 17 are electrically bonded to a plurality of electrode pads 40d on the distal end portion 47b by means of conductive adhesives such as solder or silver paste. Thus, the magnetic head 17 is connected to the signal wiring line of the flexure 40 via the electrode pads 40d.

The joint portion between the base plate 38 and the load beam 42 will now be described.

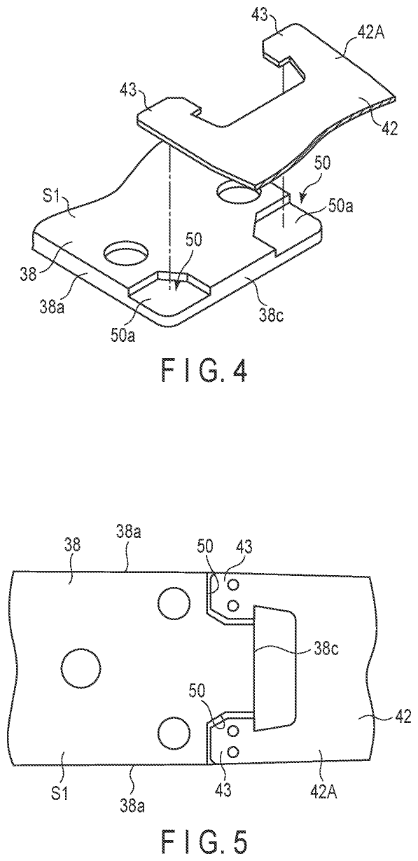

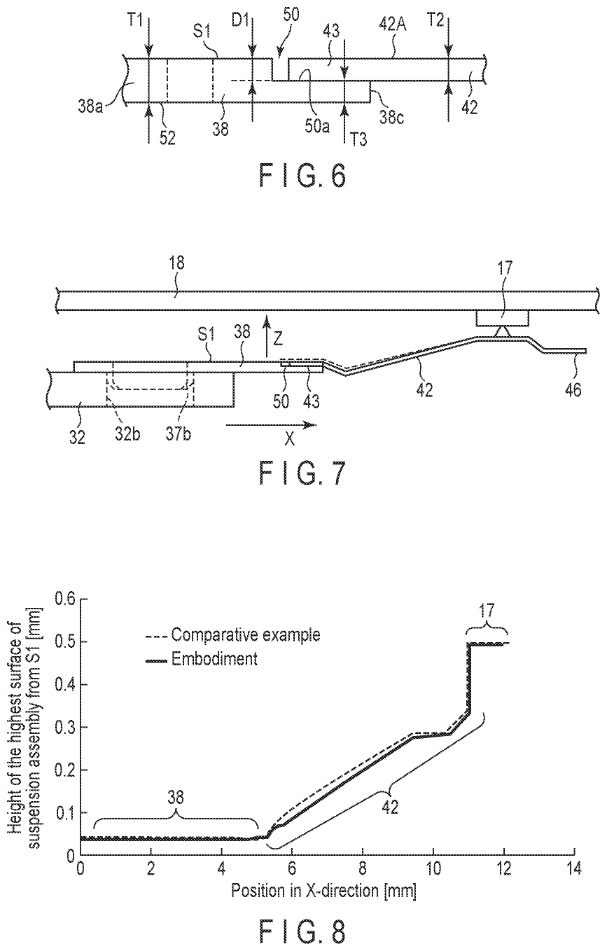

FIG. 4 is an exploded perspective view showing the distal end portion of the base plate and the proximal end portion of the load beam. FIG. 5 is a plan view showing the distal end portion of the base plate and the proximal end portion of the load beam in the joined state, and FIG. 6 is a side view showing the base plate and the load beam.

As shown in FIG. 4, in the distal end portion of the base plate 38, a pair of substantially rectangular-shaped recesses 50 are formed on a side of the first main surface S1. The pair of recesses 50 are spaced apart from each other in the width direction of the base plate 38 and are each located at a respective corner on a distal end portion side of the base plate 38. Each recess 50 forms a step portion lower than the first main surface S1. The recesses 50 are opened in the first main surface S1 of the base plate 38, the side edges 38a and the distal end edge 38c, and bottom surfaces 50a thereof extend substantially parallel to the first main surface S1. The recesses 50 are formed by coining (or pressing) during the molding of the base plate 38, or after forming the base plate 38 by etching.

As shown in FIGS. 5 and 6, the pair of proximal end portions 43 of the load beam 42 are respectively located in the recesses 50 and are in tight contact with the bottom surfaces 50a of the recesses 50. In this state, the proximal end portions 43 are welded and fixed to the base plate 38.

For example, when a thickness T1 of the base plate 38 is 100 to 130 μm, and a thickness T2 of the load beam 42 is 20 to 30 μm, a depth D1 of each recess 50 (a distance between the first main surface S1 and the bottom surface 50a) is less than or equal to the thickness T2, for example, 20 to 30 μm. In the base plate 38, the portion where the recesses 50 are formed is a thin portion (stepped portion) with a reduced thickness. A thickness T3 of the thin portion is 70 to 100 μm.

By placing the proximal end portions 43 in the recesses 50 as described above, the load beam 42 is placed on a lower position by the depth D1 of the recess 50, that is, a position away from the magnetic disk 18, as compared to the case where when it is placed on the first main surface S1 of the base plate 38. For example, the upper surface 42A of the proximal end portion 43 extends to be substantially flush with the first main surface S1 of the base plate 38.

FIG. 7 is a side view of the head suspension assembly of the present embodiment and a head suspension assembly of a comparative example in comparison with each other, illustrating the positional relationship between the head suspension assembly and the magnetic disk 18. FIG. 8 is a side view showing the height from the first main surface S1 to the uppermost surface of the head suspension assembly at each position in the X-direction (the height in the Z-direction perpendicular to the first main surface S1). FIG. 8 shows the results of calculating the profile of the upper surface of the suspension assembly when the head is loaded on the magnetic disk using the finite element method. In calculating the profile, the set values of the HDD are, for example, eleven magnetic disks installed, a disk thickness of 0.5 to 0.6 mm, an interval between adjacent pair of magnetic disks of 1.3 to 1.5 mm, an arm thickness of 0.5 to 0.5 mm, a base plate thickness of 0.1 to 0.13 mm, a load beam thickness of 0.02 to 0.03 mm, and a flexure plate thickness of 0.03 to 0.39 mm.

In FIGS. 7 and 8, the head suspension assembly of this embodiment is indicated by a solid line, and the head suspension assembly of the comparative example is indicated by a dashed line. It is assumed that the load beam of the head suspension assembly of the comparative example is joined directly on the first main surface S1 of the base plate 38.

As can be seen from FIGS. 7 and 8, the proximal end portion of the load beam 42 in this embodiment is disposed in the recess 50 of the base plate 38, and therefore the Z-height of the load beam 42 of this embodiment is lower than the Z-height of the load beam of the comparative example. In other words, the distance Z between the load beam and the magnetic disk is greater in the load beam of this embodiment than in the load beam of the comparative example. In particular, in the middle portion of the load beam 42 in the X direction, the difference between the Z-height of the load beam of the embodiment and the Z-height of the load beam of the comparison example is large.

According to the HDD of this embodiment configured as described above, the distance Z between the magnetic disk 18 and the load beam 42 can be widened, and the risk of contact between the load beam 42 and the magnetic disk 18 due to impact, etc., during loading can be lowered. In terms of the resonance characteristics of the suspension, the thickness of the twisting center of the base plate 38 is not changed, but only the distal end portion of the base plate separated from the twisting center is made thinner and lighter, and therefore the reduction in rigidity of the base plate and the weight reduction are cancelled off and the effect on the resonance characteristics are reduced. Further, recesses are provided only at the distal end portion of the base plate to reduce the weight, and therefore the formability of the projecting portion (flange) for caulking the base plate is not substantially affected.

As described above, according to this embodiment, a suspension assembly which can prevent contact with a recording medium and a magnetic disk device comprising the suspension assembly can be obtained.

Next, the head suspension assembly of the HDD according to another embodiment will be described. In the other embodiments described below, parts identical to those the first embodiment described above will be denoted by the same reference symbols, and their detailed descriptions will be omitted or simplified.

Only the parts different from those the first embodiment will be mainly described in detail.

### Second Embodiment

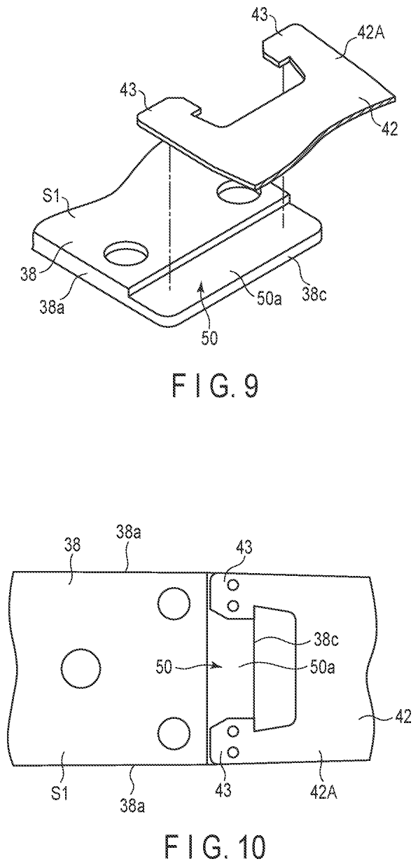

FIG. 9 is an exploded perspective view showing a distal end portion of a base plate and a proximal end portion of a load beam in an head suspension assembly of an HDD according to a second embodiment. FIG. 10 is a plan view showing the distal end portion of the base plate and the proximal end portion of the load beam in a joined state.

As shown in the figure, according to the second embodiment, a recess 50 formed in the distal end portion of the base plate 38 extends over the entire widthwise length of the base plate 38. In other words, the pair of recesses 50 shown in the first embodiment may be formed into one continuous recess with respect to each other. A pair of proximal end portions 43 of the load beam 42 are placed and overlaid on the bottom surface 50a of the recess 50 and fixed to the base plate 38 by welding.

In the second embodiment, the other configuration of the head suspension assembly is identical to the head suspension assembly of the first embodiment described above. In the second embodiment, advantageous effects similar to those of the first embodiment provided above can be obtained.

The shape of the recess 50 is not limited to a rectangular shape, but can be changed in various ways as needed.

### Third Embodiment

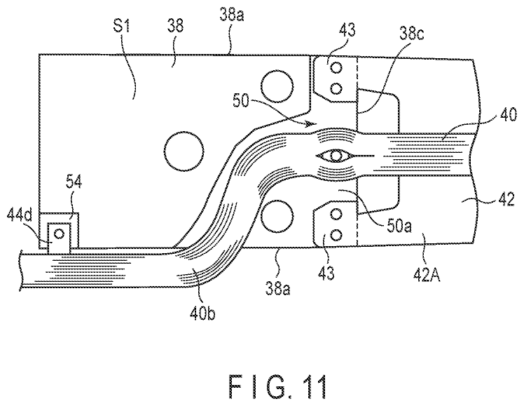

FIG. 11 is a plan view showing a head suspension assembly for HDD according to the third embodiment, illustrating a distal end portion of a base plate, a proximal end portion of a load beam and a flexure.

As shown in the figure, according to the third embodiment, a recess 50 formed in the distal end portion of the base plate 38 extends over the entire widthwise length of the base plate 38. Further, the recess 50 extends diagonally toward the proximal end portion of the base plate 38 and to one side edge 38a of the base plate 38. Further, in a first main surface S1 of the base plate 38, a second recess 54 is provided at the proximal end portion of the base plate 38. The second recess 54 has a rectangular shape, for example, and is opened in the proximal end portion of the base plate 38 and the one side edge 38a.

A pair of proximal end portions 43 of the load beam 42 are placed and overlaid on a bottom surface 50a of the recess 50 and fixed to the base plate 38 by welding. A part of the flexure 40 provided on the load beam 42, that is, a latter half portion (extending portion) 40b extends outwardly from the side edge of the base plate 38 via the recess 50 and further extends along the side edge of the respective arm 32. A part of the later half portion 40b is disposed in contact with the bottom surface 50a of the recess 50 and further a part of the second half portion 40b is welded to the bottom surface 50a.

The latter half portion 40b of the flexure 40 includes a tongue 44d protruding from its side edge toward the side of the base plate 38. The tongue portion 44d is disposed within the second recess 54 and is fixed to the bottom surface of the second recess 54, for example, by welding.

In the third embodiment, the other configuration of the head suspension assembly is identical to the head suspension assembly of the first embodiment described above. In the third embodiment, advantageous effects similar to those of the first embodiment provided above can be obtained. Furthermore, according to the third embodiment, by placing a part of the flexure 40 in the recess 50 of the base plate 38, the gap between the flexure 40 and the magnetic disk 18 can be widened, thereby reducing the risk of contact between the flexure 40 and the magnetic disk 18. Thus, according to this embodiment, a suspension assembly which can prevent contact with the recording medium and a magnetic disk device comprising the same can be obtained.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the number of magnetic disks installed is not limited to ten, but can be increased to eleven or twelve. The proximal end portion of the load beam is not limited to a two-way split configuration, but can as well be a proximal end portion that extends continuously in the width direction. The shape of the recess can be changed as desired to match the shape of the proximal end portion of the load beam. The bottom surface of the recess is not limited to a configuration parallel to the first main surface of the base plate, but may as well be a bottom surface inclined with respect to the first main surface.

What is claimed is:

1. A head suspension assembly comprising:
a base plate including a first main surface, a second main surface opposing the first main surface, a distal end portion and a recess formed in the distal end portion on a side of the first main surface;
a load beam including a proximal end portion disposed in the recess and fixed to a bottom surface of the recess, and extending from the base plate;
a wiring member arranged on the first main surface of the base plate and the load beam; and
a magnetic head supported by the load beam via the wiring member.

2. The head suspension assembly of claim 1, wherein
the recess has a depth greater than or equal to a thickness of the load beam.

3. The head suspension assembly of claim 1, wherein
a thickness of the base plate at the recess is ½ or less than a thickness of other portions of the base plate.

4. The head suspension assembly of claim 1, wherein
the recess includes a pair of recesses provided to be spaced apart from each other in a width direction of the base plate, and
the proximal end portion of the load beam includes a pair of proximal end portions located to be spaced apart from each other in a width direction of the load beam, the pair of proximal end portions are disposed in the pair of recesses, respectively, and welded to bottom surfaces of the recesses.

5. The head suspension assembly of claim 1, wherein
the recess extends over a full width of the base plate, and
the proximal end portion of the load beam includes a pair of proximal end portions spaced apart from each other in the width direction of the load beam, and the pair of proximal end portions are disposed in the recess, respectively, and welded to the bottom surface of the recess.

6. The head suspension assembly of claim 1, wherein
the proximal end portion includes a lower surface in contact with the bottom surface of the recess and an upper surface on an opposite side thereto, and
the upper surface of the proximal end portion is flush with the first main surface of the base plate.

7. The head suspension assembly of claim 1, wherein
the base plate includes a pair of side edges opposing each other and a distal end edge intersecting the pair of side edges, and the recess is open to the first main surface, the side edges, and the distal end edge.

8. The head suspension assembly of claim 7, wherein
the bottom surface of the recess extends parallel to the first main surface.

9. The head suspension assembly of claim 1, wherein
a part of the wiring member is disposed within the recess.

10. A disk device comprising:
a rotatable magnetic disk; and
an actuator assembly including an arm and a head suspension assembly of claim 1, attached to the arm.

11. The disk device of claim 10, further comprising eleven magnetic disks each having a thickness of 0.5 to 0.6 mm and arranged with an interval of 1.3 to 1.45 mm therebetween,
wherein the actuator assembly includes a plurality of arms each having a thickness of 0.65 to 0.9 mm, and
a thickness of the base plate is 0.1 to 0.13 mm, a thickness of the load beam is 0.02 to 0.03 mm and a thickness of the wiring member is 0.03 to 0.39 mm.

12. The disk device of claim 10, wherein
a thickness of the base plate at the recess is ½ or less than a thickness of other portions of the base plate.

13. The disk device of claim 10, wherein
the recess includes a pair of recesses provided to be spaced apart from each other in a width direction of the base plate, and
the proximal end portion of the load beam includes a pair of proximal end portions located to be spaced apart from each other in a width direction of the load beam, the pair of proximal end portions are disposed in the pair of recesses, respectively, and welded to bottom surfaces of the recesses.

14. The disk device of claim 10, wherein
the recess extends over a full width of the base plate, and
the proximal end portion of the load beam includes a pair of proximal end portions spaced apart from each other in the width direction of the load beam, and the pair of proximal end portions are disposed in the recess, respectively, and welded to the bottom surface of the recess.

15. The disk device of claim 10, wherein
the proximal end portion includes a lower surface in contact with the bottom surface of the recess and an upper surface on an opposite side thereto, and
the upper surface of the proximal end portion is flush with the first main surface of the base plate.
